(19) United States
(12) Patent Application Publication
(10) Pub. No.: US 2005/0049887 A1
(43) Pub. Date: Mar. 3, 2005

(54) Methods, systems, and computer program products for allocating costs in using a broadband communication network

(76) Inventors: Douglas A. Bulleit, Atlanta, GA (US); Keith O. Cowan, Atlanta, GA (US); Barbara Roden, Atlanta, GA (US)

Correspondence Address: MYERS BIGEL SIBLEY & SAJOVEC, P.A., P.O. BOX 37428, RALEIGH, NC, 27627, US

(21) Appl. No.: 10/652,815

(22) Filed: Aug. 29, 2003

(51) Int. Cl. G06F 17/60

(52) U.S. Cl. 705/1

(57) ABSTRACT

A broadband communication network is operated by establishing a communication flow between a network access terminal and a site using the broadband communication network. A cost of the communication flow between the network access terminal and the site is allocated between a first account associated with a user of the network access terminal and a second account associated with an entity other than the user of the network access terminal.

### FIELD OF THE INVENTION

The present invention relates to communication networks, and, more particularly, to broadband communication networks.

### BACKGROUND OF THE INVENTION

The Internet has in recent years become a mainstream commercial communication resource. The Internet provides a real-time, paper-free, cost-effective mode of communication and resource sharing through which sellers of goods and services can reach millions of potential customers. E-mail and remote access to computer servers are currently widely used tools for reaching computer literate potential customers.

The participants in the Internet are a wide variety of machines, organizations, and individuals, all able to communicate and share information. Physically, the Internet is an interconnected collection of thousands of computer networks, tens of thousands of computers, and tens of millions of individual stations operated by end-users. The Internet works because all of these computers share compatible communication protocols and addressing schemes that make e-mail, remote resource access, file transferring, and file sharing possible throughout the system.

The backbone of the Internet is a group of networks forming an international grid of high-speed, high-capacity data communication lines interconnecting a number of massive computers that serve as large-scale processing points or nodes. These backbone networks are interconnected with each other through a plurality of interconnection points known as network access points. The backbone nodes are collectively responsible for capturing and sorting incoming information, routing information to its intended destination, and forwarding data between backbone nodes.

The Internet was originally used only for academic and governmental purposes. In recent years, however, the Internet has been opened to commercial traffic. In the United States, commercial access to the Internet may be obtained at numerous hosts located throughout the country. A host is a computer connected to the Internet and configured with Internet routing software. A host may be a massive super computer, a mainframe-processing machine, a minicomputer, a workstation, or even a personal computer. Hosts may serve three principal functions: First, they send and receive Internet communication traffic. Second, they provide the gateway between the Internet and end-users. And third, they provide web servers that operate as repositories of information and resources that may be accessed over the Internet. For example, these web servers provide “home pages” to be visited, files to be read or downloaded, applications to be shared, and the like.

The physical structure of Internet is therefore relatively complex, but to the end-user it appears to be a virtually seamless network in which the computer on the desk next door may be accessed as easily as that of a commercial supplier in another city, or that of university in another country. To access any Internet site, an end-user need only transmit the site's universal resource locator (URL) created in accordance with the standardized Domain Name System (DNS). The Internet hosts and nodes respond to the URL by connecting the end-user's station with the Internet site associated with the requested URL.

At present, the operator of each Internet site is responsible for paying the cost of obtaining a communication channel with the Internet. Once an end-user establishes a communication channel with the Internet, connections may be made with other Internet sites by transmitting URLs in accordance with the DNS system. An Internet site may therefore be established by providing a host and obtaining a communication channel between that host and the Internet.

Although commercial users must now pay a fee to use the Internet, the Internet is generally popular with commercial users and individuals, at least in part, because it is relatively cost effective. At present, each commercial user typically pays the cost of physically obtaining a connection to the Internet, plus a relatively modest monthly Internet connection fee based on the capacity of the connection and in some cases the actual data transfer volume. In general, no connect-time-based, destination-based, or other incremental charges are currently imposed for browsing, e-mail, and resource sharing. Thus, a dedicated connection to the Internet effectively serves as a flat rate international browsing, messaging, and resource sharing service.

An Internet site may be connected to the Internet through a wide range of physical communication channels providing various levels of information carrying capacity. Typically, the minimum service available that gives the Internet site access to the full array of Internet services 24 hours a day is a single “dial-up” Internet communication channel. Higher capacity communication channels are available at higher cost. For example, optical fiber, wireless, and leased telephone lines ranging from 56 kilo-bits-per-second to 1.544 mega-bits-per-second (T1) are typical options available to an Internet site. In addition to these access charges, the operator of an Internet site also typically pays the cost of obtaining a physical communication channel with the Internet.

Many Internet sites are operated by commercial suppliers that sell products and services. These commercial suppliers may use the Internet to cost-effectively communicate with existing and prospective consumers. To a commercial supplier, the cost of maintaining an Internet site is a cost of doing business, much like postage, electricity, and advertising. Indeed, the Internet may be one of the more cost-effective marketing resources available to a commercial entity.

Other Internet sites are points of presence operated by local access providers that, in turn, provide Internet access to millions of end-user Internet sites. Obtaining access through a local access provider is typically the least expensive way for an individual end-user to access the Internet. These points of presence therefore operate as gateways between the Internet sites of commercial suppliers and millions of end-users. A local access provider recovers the cost of its Internet communication channel and earns its profits through Internet access fees charged to its customers. For example, a local access provider may charge an end-user a flat rate plus a charge per unit of connect time.

Between an individual end-user and a local access provider's point of presence lies a communications network, such as a telephone network, a cable television network, a wireless communications network, or the like. This communications network is typically operated by a for-profit enterprise. An end-user therefore pays a cost for using the communications network. In the United States, most homes and businesses are already connected to a telephone network. These telephone networks are therefore convenient options for end-users desiring communication channels with the Internet. Other communications networks, however, may equivalently be used to provide Internet access.

The economics of using a communications network, particularly the telephone network, is therefore a factor in the operation of the Internet as a commercial resource. For an end-user lucky enough to have a local access provider's point of presence located within the same telephone exchange area, the Internet is only a local telephone call away. For other less fortunate end-users, long-distance telephone charges are incurred. For these end-users, even moderate Internet use of a few hours a week can result in significant long-distance telephone charges.

In addition, operators of Web sites on the Internet may provide their customers with various features or performance options, such as download speeds, that can be selected by their customers when visiting the site. To take advantage of some of these options or performance options, a customer may need to have subscribed to a certain throughput level or bandwidth from an Internet Service Provider (ISP). Unfortunately, this typically requires the end user to bear the bulk of the cost for using various features or performance enhancements provided by Web site operators on the Internet.

The public switched telephone network (PSTN) provides a cost allocation mechanism for voice services. For example, 800 numbers are provided that allow a business, for example, to receive calls from customers so that the business is responsible for any toll charges associated with the calls. Other numbers, such as 900 numbers, may be used to allocate a portion of the cost of the call to the customer and another portion of the cost of the call to the business. Unfortunately, a more flexible allocation methodology for costs associated with the access and use of a broadband communication network, such as the Internet, and the features and performance options provided thereon is not currently available.

### SUMMARY OF THE INVENTION

According to some embodiments of the present invention, a broadband communication network is operated by establishing a communication flow between a network access terminal and a site using the broadband communication network. A cost of the communication flow between the network access terminal and the site is allocated between a first account associated with a user of the network access terminal and a second account associated with an entity other than the user of the network access terminal.

In accordance with other embodiments of the present invention, the cost of the communication flow may be allocated based on a performance level of the communication flow.

In accordance with still other embodiments of the present invention, the cost of the communication flow is allocated between the first account and the second account based on whether the communication flow is at a base performance level or an enhanced performance level that exceeds the base performance level.

In accordance with still other embodiments of the present invention, a request is received from the network access terminal and/or the site to provide the communication flow at the enhanced performance level. The communication flow is then provided at the enhanced performance level.

In further embodiments of the present invention, the cost of the communication flow comprises a base cost for operating the communication flow at a base performance level and an incremental cost, in addition to the base cost, for operating the communication flow at an enhanced performance level. In accordance with various embodiments of the present invention, the base cost may be allocated to the first account and the incremental cost may be allocated to the second account. Alternatively, the base cost and the incremental cost may both be allocated to the first account or both allocated to the second account.

In still other embodiments of the present invention, an authentication mechanism may be used to verify that the network access terminal and/or the site is authorized to modify the performance level of the broadband communication network and/or allocation of the cost of the communication flow. When a second request is received from the network access terminal and/or the site to provide the communication flow at the base performance level, the cost of the communication flow between the network access terminal and the site may be allocated between the first account associated with the user of the network access terminal and the second account associated with at the entity other than the user of the network access terminal based on the performance level of the communication flow if the network access terminal and/or the site is authorized to modify the performance level of the broadband communication network and/or allocation of the cost of the communication flow.

In further embodiments of the present invention, the entity may be associated with a site or with a third party that is not associated with the site.

In still further embodiments of the present invention, the performance level is based one or more of the following criteria: bandwidth of the communication flow, duration of the communication flow, latency associated with the communication flow, jitter associated with the communication flow, dropped packets associated with the communication flow, quality of service (QoS) associated with the communication flow, rate limit associated with the communication flow, traffic shaping associated with the communication flow, and priority of the communication flow.

Although described above primarily with respect to method embodiments of the present invention, it will be understood that the present invention may be embodied as methods, systems, and computer program products.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Other features of the present invention will be more readily understood from the following detailed description of specific embodiments thereof when read in conjunction with the accompanying drawings, in which:

FIG. 1 is a schematic that illustrates a broadband communication network in accordance with some embodiments of the present invention;

FIG. 2 is a block diagram that illustrates a point of presence node for use in a broadband communication network in accordance with some embodiments of the present invention; and

FIGS. 3 and 4 are flowcharts that illustrate operations for allocating costs in a broadband communication network in accordance in accordance with some embodiments of the present invention.

### DETAILED DESCRIPTION OF EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

The present invention may be embodied as systems, methods, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

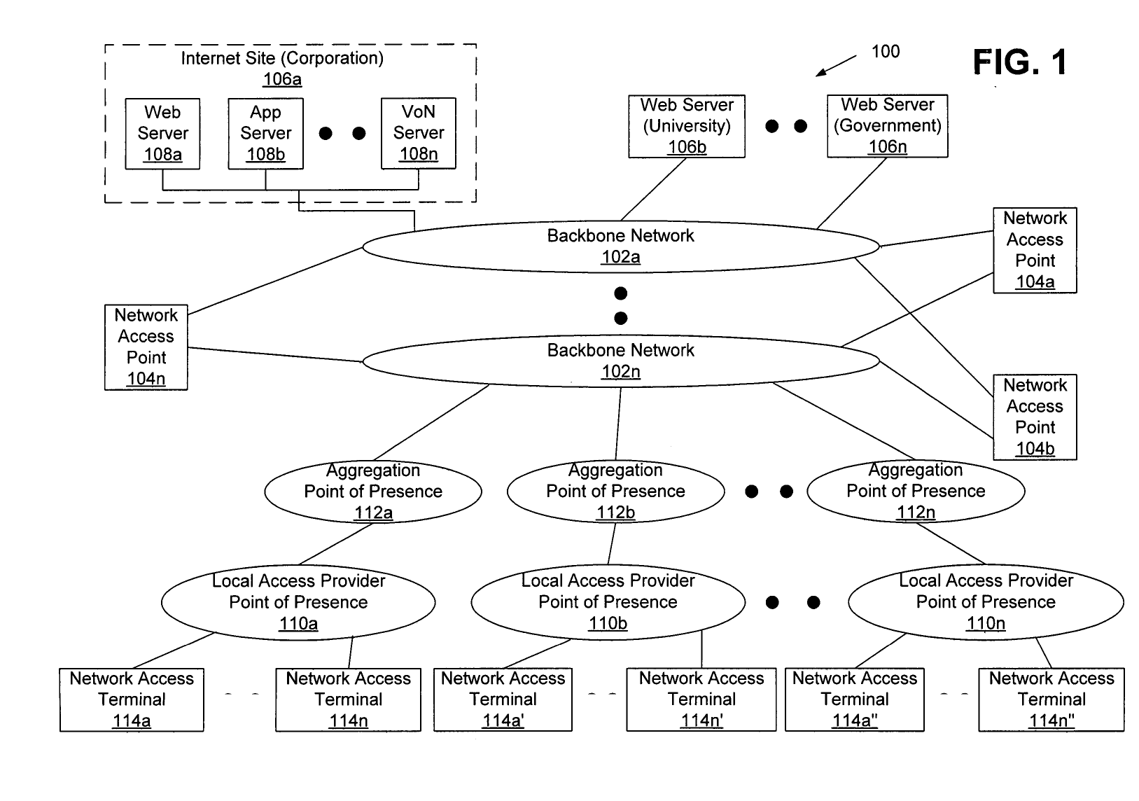

Referring now to FIG. 1, an exemplary broadband communication network 100, in accordance with some embodiments of the present invention, comprises a plurality of backbone networks 102a through 102n. These backbone networks form an international grid of high-speed, high-capacity data communication lines interconnecting a number of massive computers that serve as large-scale processing points or nodes. The backbone networks 102 are interconnected with each other through a plurality of network access points 104a through 104n. These network access points are interfaces through which information is communicated from one backbone network to another. The configuration and operation of the Internet backbone is well known to those skilled in the art and will not be further described herein.

The broadband communication network 100 comprises a variety of participants that are able to communicate and share information with each other. For example, the broadband communication network comprises a plurality of Internet sites 106a through 106n. These Internet sites are generally operated by corporations, universities, and/or governmental organizations. Each Internet site may comprise one or more repositories of information and resources that may be accessed over the Internet. Each Internet site, as represented, for example, by the Internet site 106a, may comprise a plurality of web servers 108a through 108n corresponding to a web server, application server, and voice over network server, respectively. Each of these web servers may provide “home pages” to be visited, files to be read or downloaded, applications to be shared, and the like.

The broadband communication network 100 also comprises a plurality of points of presence. As shown in FIG. 1, points of presence 110a through 110n are operated by local access providers and points of presence 112a through 112n are operated by service providers at the edge of Internet Protocol (IP) network. The local access providers are in the business of providing Internet access to network access terminals or end-user stations 114a through 114n, 114a′ through 114n′, and 114a″ through 114n″. All together, the points of presence 110a through 110n and 112a through 112n can provide Internet access to numerous network access terminals 114. Each point of presence 110a through 110n and 112a through 112n, and each network access terminal 114, may, but need not, provide home pages for access by others on broadband communication network 100.

Although FIG. 1 illustrates an exemplary broadband communication network 100, it will be understood that the present invention is not limited to such a configuration, but is intended to encompass any configuration capable of carrying out the operations described herein.

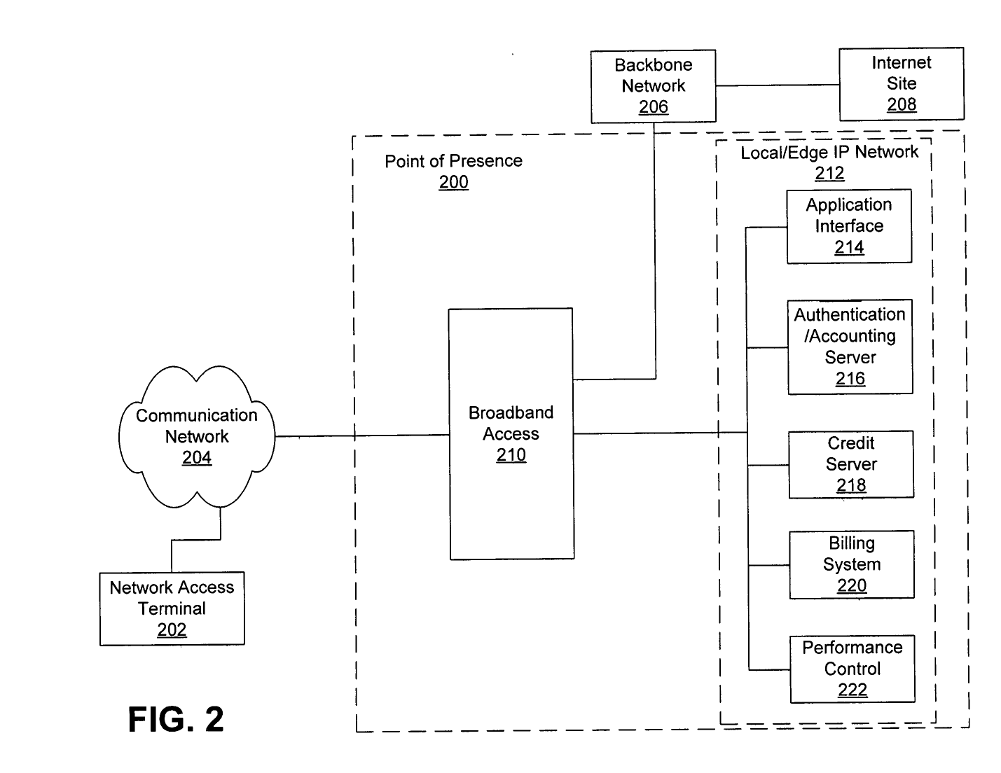

Referring now to FIG. 2, a point of presence node for use in a broadband communication network, in accordance with some embodiments of the present invention, will now be described. As shown in FIG. 2, a point of presence node 200 may be used to provide access to a broadband communication network for one or more end user stations 202 via a communication network 204. The communication network 204 may comprise both narrowband and broadband (e.g., xDSL, cable modem, fixed wireless, 3G wireless, and/or other private and/or public networks or combinations thereof) elements in accordance with various embodiments of the present invention. The point of presence node 200 provides an interface between the communication network 204 and a backbone network 206 through which an Internet site 208 may be accessed. In accordance with various embodiments of the present invention, the point of presence node 200 may be used to implement the local access provider point of presence nodes 110 and/or the aggregation point of presence nodes 112 of FIG. 1.

The point of presence node 200 comprises a broadband access node 210 and a local network/edge IP network 212, in accordance with some embodiments of the present invention. The broadband access node 210 may be configured to facilitate communication between the communication network 204 and the backbone network 206. In particular, the broadband access node 210 maybe configured under the control of the local network/edge IP network 212 to manage communication flows between an end user station 202 and an Internet site 208. As used herein, a communication flow may be defined in multiple ways in accordance with various embodiments of the present invention. For example, a flow may be defined based on a combination of source and a destination address, source and destination socket numbers, and/or a session identifier. In other embodiments, a flow may be defined as any packet from a certain application and/or from an incoming interface. In still other embodiments, a flow may be defined based on a particular URL or MIME type contained in an HTTP packet.

According to some embodiments of the present invention, the point of presence module 200 may be configured to facilitate the allocation of cost of a communication flow between a network access terminal, such as a an end user station 202, and a site, such as an internet site 208, to one or more accounts, such as a first account associated with the network access terminal and another account associated with an entity other than the network access terminal. The cost allocation may be based on a performance level of the communication flow. The performance level may be based on one or more criteria including, but not limited to, characteristics such as bandwidth, duration, latency, jitter, dropped packets, quality of service (QoS), rate limits, traffic shaping, and/or priority.

In accordance with other embodiments of the present invention, costs other than the cost associated with using a broadband communication network may also be allocated among multiple parties and/or accounts. For example, the operator of an accessed Internet site 208 may charge the accessing network access terminal 202 a fee for accessing the Internet site 208. This cost may be allocated to an account associated with the network access terminal 202, collected by the operator of the point of presence 200, and paid to the operator of the Internet site 208. Alternatively, the operator of the accessed Internet site 208 may sell goods or services to the operator of the network access terminal 202 (or vice-versa). The cost of these goods or services may be allocated to an account associated with the network access terminal 202 (or the accessed Internet site 208), collected by the operator of the point of presence 200, and paid to the operator of the Internet site 208 (or the network access terminal 202).

In addition, the allocation methodology may consider other allocation parameters in addition to or instead of one or more of the performance based parameters described above, such as the distance between the network access terminal (e.g., end user station) and the accessed site, the time of day, the data transfer volume, resources utilized, applicable membership status, and/or any other measurable parameter. For example, other embodiments of the present invention may use more elaborate cost allocation methodologies, such as time-based rates, capacity-based rates, distance-based rates, usage-based rates, content-based rates, and the like. As one alternative, the operator of an accessed site 208 may be allocated the cost of the first five minutes of access, and the accessing end-user (e.g., via network access terminal 202) allocated the remainder. As another alternative, the operator of an accessed site 208 may be allocated a relatively small cost during peak usage hours and a larger cost during off-peak hours to encourage efficient usage patterns of its Internet resources.

Furthermore, as discussed above, an entity that is not associated with the network access terminal may be allocated a portion of a cost associated with providing a particular end-user with access to particular Internet sites. In some embodiments, this entity may be associated with the accessed site. In other embodiments, a third party, such as a parent, may pay for a child's Internet access as a gift while the child is away at school. For example, to do so, the parent establishes an account with the child's local access provider, and gives the local access provider a list of Internet sites for which the parent will accept “reversed” Internet access charges. The cost of providing the child with access to the Internet sites on the list, and only those on the list, is then allocated to the parent's account. It will therefore be appreciated that a wide variety of Internet-based commercial transactions may be facilitated in accordance with various embodiments of the present invention.

Returning to FIG. 2, the local network/edge IP network 212 comprises an application interface module 214, an authentication/accounting server 216, a credit server 218, a billing system 220, and a performance control module 222. The application interface 214 may be configured to provide a generally accessible API for hosts to interact with the point of presence node 200. The authentication/accounting server 216 may be configured to implement an authentication mechanism for verifying whether a network access terminal and/or a site is authorized to modify the performance of the broadband communication network and/or the allocation of costs of using the broadband communication network between various accounts. In accordance with some embodiments, the application may generate a key that may be transmitted to a network access terminal and/or an accessed site that may be used as a security measure when determining how to allocate the costs of a communication flow. The authentication/accounting server 216 may be further configured to record the connect time for communication flows established between network access terminals, such as the end user station 202 and Internet sites 208 over the broadband communication network. Moreover, the authentication/accounting server may record times in which a communication flow is given a particular level of performance, such as a base level of performance and/or an enhanced level of performance as defined, for example, by the various performance criteria described above. The credit server 218 may be configured to generate time stamps for messages received from network access terminals, such as end user station 202, and/or sites, such as Internet site 208, to identify when performance modifications are requested for communication flows. The billing system 220 may be configured to allocate the costs of communication flows between accounts associated with users of network access terminals and accounts associated with entities other than users of network access terminals, in accordance with some embodiments of the present invention, and to render the resulting invoices. The performance control server 222 may be configured to cooperate with the broadband access node 210 to manage communication flows through the broadband communication network. This management may comprise adjusting the performance levels of the communication flows based on one or more of the performance criteria discussed above, including, but not limited to, bandwidth, duration, latency, jitter, dropped packets, quality of service (QoS), rate limits, traffic shaping, and/or priority.

Although FIG. 2 illustrates an exemplary architecture for a point of presence node 200, it will be understood that the present invention is not limited to such a configuration, but is intended to encompass any configuration capable of carrying out the operations described herein. The local network/edge IP network 212 may comprise a local area network (LAN), wide area network (WAN), Ethernet, Appletalk, or other network configurations in accordance with various embodiments of the present invention. The computing elements comprising the local network/edge IP network 212 may be discrete data processing systems. In other embodiments, the functionality of one or more of these computing elements may be combined into a single data processing system. Moreover, it will be appreciated that, in accordance with some embodiments of the present invention, the functionality of the local network/edge IP network 212 may be implemented using discrete hardware components, one or more application specific integrated circuits (ASICs), a programmed digital signal processor or microcontroller, a program stored in a memory and executed by a processor, and/or combinations thereof. In this regard, computer program code for carrying out operations of the point of presence node 200 may be written in a high-level programming language, such as C or C++, for development convenience. In addition, computer program code for carrying out operations of the present invention may also be written in other programming languages, such as, but not limited to, interpreted languages. Some modules or routines may be written in assembly language or even micro-code to enhance performance and/or memory usage.

The present invention is described hereinafter with reference to flowchart and/or block diagram illustrations of methods, systems, and computer program products in accordance with exemplary embodiments of the invention. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

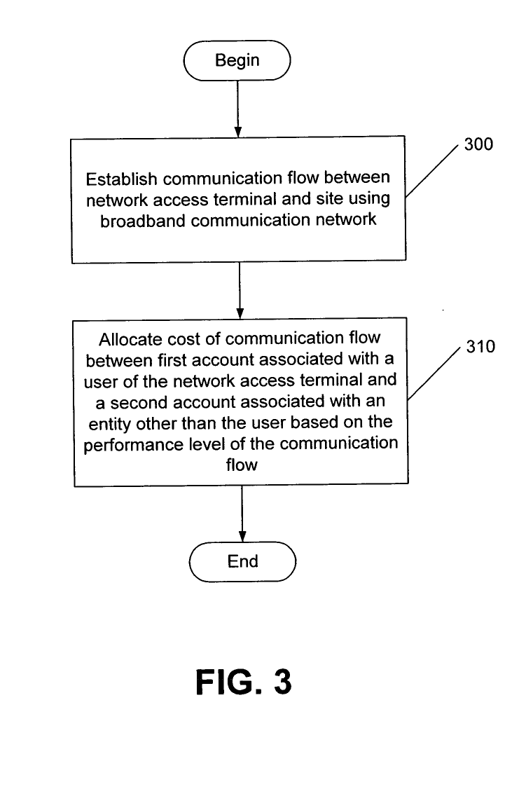

Referring now to FIG. 3, operations for allocating costs in using a broadband communication network, in accordance with some embodiments of the present invention, will now be described. Operations begin at block 300 where a communication flow between a network access terminal, such as the network access terminals/end user stations 114 of FIG. 1 and/or the network access terminal/end user station 202 of FIG. 2, and a site, such as the Internet sites 106 of FIG. 1 and/or the Internet site 208 of FIG. 2, is established. At block 310, a point of presence node, such as the point of presence node 200 of FIG. 2, may allocate the cost of the communication flow between a first account associated with a user of the network access terminal and a second account associated with an entity other than the user. The cost allocation may be based on a performance level of the communication flow, which may be determined based on one or more of the following criteria: bandwidth, duration, latency, jitter, dropped packets, quality of service (QoS), rate limits, traffic shaping, and/or priority. Thus, according to embodiments of the present invention, costs of providing particular levels of performance or features via a communication flow may be allocated between multiple entities including, for example, a user of a network access terminal, an entity associated with an accessed site, such as an Internet site, and/or a third party that is not associated with either of the parties participating in the communication flow, but may have agreed to be responsible for one or more of the costs.

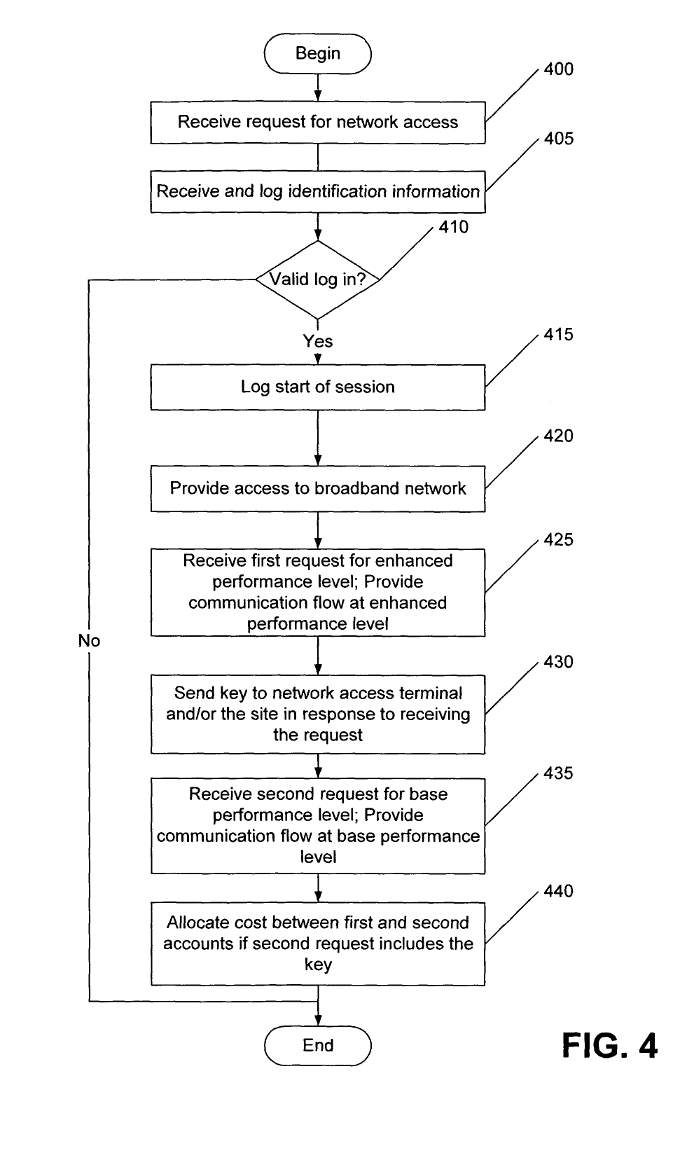

Referring now to FIG. 4, operations for allocating costs in using a broadband communication network, in accordance with other embodiments of the present invention, will now be described. Operations begin at block 400 where the point of presence node, for example, the point of presence node 200, receives a request to access the broadband communication network, such as the broadband communication network 100 of FIG. 1. The authentication/accounting server 216 of FIG. 2 may receive the login information and verify whether this user is authorized to access the broadband communication network. If the login is invalid as determined at block 410, then operations end. Otherwise, operations continue at block 415 where the authentication/accounting server 216 logs the start of the communication session for a particular user using a network access terminal, such as the network access terminal 202 of FIG. 2 and/or the end user stations 114 of FIG. 1.

At block 420, the point of presence node 200 provides access to the broadband network to the network access terminal. A user may access various sites on the broadband network using, for example, an Internet browser. At block 425, the point of presence node 200 receives a request from either the network access terminal or a site visited by the network access terminal for an enhanced performance level. Thus, for example, a user may invoke such a request for enhanced performance by selecting an option on a web page for enhanced performance. Alternatively, an Internet site may provide enhanced performance to any visitor of that site. In other embodiments, a user may have an interface on a network access terminal that provides an option for enhanced performance regardless of which site the user visits. It will be understood that these invocation options are presented for purposes of illustration only. Other invocation techniques can be used in accordance with other embodiments of the present invention. As discussed above, the communication flow may have a performance level that is based on one or more of several criteria including, but not limited to, bandwidth, duration, latency, jitter, dropped packets, quality of service (QoS), rate limits, traffic shaping, and/or priority. In response to such a request, the credit server 218 may record a time stamp associated with the request so that the duration of providing an enhanced level of performance may be calculated. In addition, the performance control server 222 may configure the broadband access node 210 to provide the enhanced performance by, for example, adjusting the priority of a communication flow, increasing a bandwidth assigned to the communication flow, adjusting a rate limit assigned to the communication flow, etc.

At block 430, the authentication/accounting server 216 may use an authentication mechanism to verify whether a network access terminal and/or a site is authorized to modify the performance of the broadband communication network and/or the allocation of costs of using the broadband communication network between various accounts. In accordance with some embodiments of the present invention, the authentication/accounting server 216 may send a key to the network access terminal and/or the site. This key may be used as a security mechanism to ensure that this communication flow is one in which costs are to be allocated based on performance level. It will be understood that the authentication mechanism is not limited to the use of a key. Other authentication and/or security mechanisms may be used in accordance with various embodiments of the present invention.

Either the network access terminal or the site may send a request to the point of presence node 200 to return to the base performance level at block 435. In response to such a request, the credit server 218 may record a time stamp associated with the request so that the duration of providing the enhanced level of performance may be calculated. In other embodiments of the present invention, the credit server 218 may store other performance related information in addition to or instead of the time stamp information. The performance related information may include, but is not limited to, bandwidth, latency, jitter, dropped packets, quality of service (QoS), rate limits, traffic shaping, and/or priority information. In addition, the performance control server 222 may configure the broadband access node 210 to provide the base level of performance by readjusting various performance parameters/criteria as have been discussed above.

Operations continue at block 440 where the billing system 220 may allocate the cost of the communication flow between the network access terminal and the site between various accounts associated with a user of the network access terminal, an operator of the site, and/or an entity that is not associated with the network access terminal nor the site. For example, in some embodiments, the cost of providing a base level of performance for the communication flow may be allocated to an account associated with the user while a cost of providing the enhanced level of performance for the communication flow is provided to either an account associated with the site and/or an account associated with an entity not associated with either the network access terminal nor the site. In other embodiments, the cost of providing the base level of performance and the enhanced level of performance may be allocated to an account associated with the user. In still other embodiments, the cost of providing the base level of performance and the enhanced level of performance may be allocated to an account associated with the site and/or an entity that is not associated with the network access terminal nor the site. These cost allocations are merely exemplary for purposes of illustrating various embodiments of the present invention. Other cost allocations may be used in accordance with other embodiments of the present invention.

In some embodiments of the present invention, the billing system 220 may not allocate the cost between multiple accounts unless the request to return to the base performance level includes the key. By ensuring that the party or parties that request an enhanced performance level are also the party or parties that request a return to a base performance level are the same, the risk of an intruder spoofing such requests to cause an unauthorized allocation of costs for using the broadband communication network may be reduced.

In other embodiments of the present invention, the billing system 220 may use the time stamps recorded by the authentication/accounting server 216 and the credit server 218 to ensure that the user of the network access terminal was indeed logged in to the broadband communication network when request(s) were made for enhanced performance or other performance modification request(s) were made. This verification through time stamps may provide an additional level of security.

The flowcharts of FIGS. 3 and 4 illustrate the architecture, functionality, and operations of some embodiments of methods, systems, and computer program products for allocating costs in a broadband communication network. In this regard, each block represents a module, segment, or portion of code, which comprises one or more executable instructions for implementing the specified logical function(s). It should also be noted that in other implementations, the function(s) noted in the blocks may occur out of the order noted in FIGS. 3 and 4. For example, two blocks shown in succession may, in fact, be executed substantially concurrently or the blocks may sometimes be executed in the reverse order, depending on the functionality involved.

Many variations and modifications can be made to the embodiments described herein without substantially departing from the principles of the present invention. All such variations and modifications are intended to be included herein within the scope of the present invention, as set forth in the following claims.

1. A method of operating a broadband communication network, comprising:
establishing a communication flow between a network access terminal and a site using the broadband communication network; and
allocating a cost of the communication flow between the network access terminal and the site between a first account associated with a user of the network access terminal and a second account associated with an entity other than the user of the network access terminal.

2. The method of claim 1, wherein allocating the cost of the communication flow comprises:
allocating the cost of the communication flow between the network access terminal and the site between the first account associated with the user of the network access terminal and the second account associated with the entity other than the user of the network access terminal based on a performance level of the communication flow.

3. The method of claim 2, wherein allocating the cost of the communication flow comprises:
allocating the cost of the communication flow between the first account and the second account based on whether the communication flow is at a base performance level or an enhanced performance level that exceeds the base performance level.

4. The method of claim 3, further comprising:
receiving a request from the network access terminal and/or the site to provide the communication flow at the enhanced performance level; and
providing the communication flow at the enhanced performance level.

5. The method of claim 4, wherein the cost of the communication flow comprises a base cost for providing the communication flow at a base performance level and an incremental cost, in addition to the base cost, for providing the communication flow at an enhanced performance level, and wherein allocating the cost of the communication flow comprises:
allocating the base cost of the communication flow between the network access terminal and the site to the first account associated with the user of the network access terminal; and
allocating the incremental cost of the communication flow between the network access terminal and the site to the second account associated with an entity other than the user of the network access terminal.

6. The method of claim 4, wherein the cost of the communication flow comprises a base cost for providing the communication flow at a base performance level and an incremental cost, in addition to the base cost, for providing the communication flow at an enhanced performance level, and wherein allocating the cost of the communication flow comprises:
allocating the base cost and the incremental cost of the communication flow between the network access terminal and the site to the first account associated with the user of the network access terminal.

7. The method of claim 4, wherein the cost of the communication flow comprises a base cost for providing the communication flow at a base performance level and an incremental cost, in addition to the base cost, for providing the communication flow at an enhanced performance level, and wherein allocating the cost of the communication flow comprises:
allocating the base cost and the incremental cost of the communication flow between the network access terminal and the site to the second account associated with an entity other than the user of the network access terminal.

8. The method of claim 3, further comprising:
using an authentication mechanism to verify that the network access terminal and/or the site is authorized to modify the performance level of the broadband communication network and/or allocation of the cost of the communication flow.

9. The method of claim 8, wherein the request is a first request, the method further comprising:
receiving a second request from the network access terminal and/or the site to provide the communication flow at the base performance level; and wherein allocating the cost of the communication flow comprises:
allocating the cost of the communication flow between the network access terminal and the site between the first account associated with the user of the network access terminal and the second account associated with at the entity other than the user of the network access terminal based on the performance level of the communication flow if the network access terminal and/or the site is authorized to modify the performance level of the broadband communication network and/or allocation of the cost of the communication flow.

10. The method of claim 2, wherein the performance level is based on at least one of bandwidth of the communication flow, duration of the communication flow, latency associated with the communication flow, jitter associated with the communication flow, dropped packets associated with the communication flow, quality of service (QoS) associated with the communication flow, rate limit associated with the communication flow, traffic shaping associated with the communication flow, and priority of the communication flow.

11. The method of claim 1, wherein the entity is associated with the site.

12. The method of claim 1, wherein the entity is associated with a third party that is not associated with the site.

13. A point of presence system, comprising:
a broadband access node that is configured to establish a communication flow between a network access terminal and a site using a broadband communication network; and
a billing system that is configured to allocate a cost of the communication flow between the network access terminal and the site between a first account associated with a user of the network access terminal and a second account associated with an entity other than the user of the network access terminal.

14. The point of presence system of claim 13, further comprising:
a performance control system that is configured to adjust a performance level of the communication flow; and
wherein the billing system is further configured to allocate the cost of the communication flow between the network access terminal and the site between the first account associated with the user of the network access terminal and the second account associated with the entity other than the user of the network access terminal based on the performance level.

15. The point of presence system of claim 14, wherein the communication flow is operable at a base performance level and an enhanced performance level that exceeds the base performance level.

16. The point of presence system of claim 14, wherein the performance level is based on at least one of bandwidth of the communication flow, duration of the communication flow, latency associated with the communication flow, jitter associated with the communication flow, dropped packets associated with the communication flow, quality of service (QoS) associated with the communication flow, rate limit associated with the communication flow, traffic shaping associated with the communication flow, and priority of the communication flow.

17. A system for operating a broadband communication network, comprising:
means for establishing a communication flow between a network access terminal and a site using the broadband communication network; and
means for allocating a cost of the communication flow between the network access terminal and the site between a first account associated with a user of the network access terminal and a second account associated with an entity other than the user of the network access terminal.

18. The system of claim 17, wherein the means for allocating the cost of the communication flow comprises:
means for allocating the cost of the communication flow between the network access terminal and the site between the first account associated with the user of the network access terminal and the second account associated with the entity other than the user of the network access terminal based on a performance level of the communication flow.

19. The system of claim 18, wherein the means for allocating the cost of the communication flow comprises:
means for allocating the cost of the communication flow between the first account and the second account based on whether the communication flow is at a base performance level or an enhanced performance level that exceeds the base performance level.

20. The system of claim 19, further comprising:
means for receiving a request from the network access terminal and/or the site to provide the communication flow at the enhanced performance level; and
means for providing the communication flow at the enhanced performance level.

21. The system of claim 20, wherein the cost of the communication flow comprises a base cost for providing the communication flow at a base performance level and an incremental cost, in addition to the base cost, for providing the communication flow at an enhanced performance level, and wherein the means for allocating the cost of the communication flow comprises:
means for allocating the base cost of the communication flow between the network access terminal and the site to the first account associated with the user of the network access terminal; and
means for allocating the incremental cost of the communication flow between the network access terminal and the site to the second account associated with an entity other than the user of the network access terminal.

22. The system of claim 20, wherein the cost of the communication flow comprises a base cost for providing the communication flow at a base performance level and an incremental cost, in addition to the base cost, for providing the communication flow at an enhanced performance level, and wherein the means for allocating the cost of the communication flow comprises:
means for allocating the base cost and the incremental cost of the communication flow between the network access terminal and the site to the first account associated with the user of the network access terminal.

23. The system of claim 20, wherein the cost of the communication flow comprises a base cost for providing the communication flow at a base performance level and an incremental cost, in addition to the base cost, for providing the communication flow at an enhanced performance level, and wherein the means for allocating the cost of the communication flow comprises:
means for allocating the base cost and the incremental cost of the communication flow between the network access terminal and the site to the second account associated with an entity other than the user of the network access terminal.

24. The system of claim 19, further comprising:
means for using an authentication mechanism to verify that the network access terminal and/or the site is authorized to modify the performance level of the broadband communication network and/or allocation of the cost of the communication flow.

25. The system of claim 24, wherein the request is a first request, the system further comprising:
means for receiving a second request from the network access terminal and/or the site to provide the communication flow at the base performance level; and wherein the means for allocating the cost of the communication flow comprises:
means for allocating the cost of the communication flow between the network access terminal and the site between the first account associated with the user of the network access terminal and the second account associated with at the entity other than the user of the network access terminal based on the performance level of the communication flow if the network access terminal and/or the site is authorized to modify the performance level of the broadband communication network and/or allocation of the cost of the communication flow.

26. The system of claim 18, wherein the performance level is based on at least one of bandwidth of the communication flow, duration of the communication flow, latency associated with the communication flow, jitter associated with the communication flow, dropped packets associated with the communication flow, quality of service (QoS) associated with the communication flow, rate limit associated with the communication flow, traffic shaping associated with the communication flow, and priority of the communication flow.

27. The system of claim 17 wherein the entity is associated with the site.

28. The system of claim 17, wherein the entity is associated with a third party that is not associated with the site.

29. A computer program product for operating a broadband communication network, comprising:
a computer readable storage medium having computer readable program code embodied therein, the computer readable program code comprising:
computer readable program code configured to establish a communication flow between a network access terminal and a site using the broadband communication network; and
computer readable program code configured to allocate a cost of the communication flow between the network access terminal and the site between a first account associated with a user of the network access terminal and a second account associated with an entity other than the user of the network access terminal.

30. The computer program product of claim 29, wherein the computer readable program code configured to allocate the cost of the communication flow comprises:
computer readable program code configured to allocate the cost of the communication flow between the network access terminal and the site between the first account associated with the user of the network access terminal and the second account associated with the entity other than the user of the network access terminal based on a performance level of the communication flow.

31. The computer program product of claim 30, wherein the computer readable program code configured to allocate the cost of the communication flow comprises:
computer readable program code configured to allocate the cost of the communication flow between the first account and the second account based on whether the communication flow is at a base performance level or an enhanced performance level that exceeds the base performance level.

32. The computer program product of claim 31, further comprising:
computer readable program code configured to receive a request from the network access terminal and/or the site to provide the communication flow at the enhanced performance level; and
computer readable program code configured to provide the communication flow at the enhanced performance level.

33. The computer program product of claim 32, wherein the cost of the communication flow comprises a base cost for providing the communication flow at a base performance level and an incremental cost, in addition to the base cost, for providing the communication flow at an enhanced performance level, and wherein the computer readable program code configured to allocate the cost of the communication flow comprises:
computer readable program code configured to allocate the base cost of the communication flow between the network access terminal and the site to the first account associated with the user of the network access terminal; and
computer readable program code configured to allocate the incremental cost of the communication flow between the network access terminal and the site to the second account associated with an entity other than the user of the network access terminal.

34. The computer program product of claim 32, wherein the cost of the communication flow comprises a base cost for providing the communication flow at a base performance level and an incremental cost, in addition to the base cost, for providing the communication flow at an enhanced performance level, and wherein the computer readable program code configured to allocate the cost of the communication flow comprises:
computer readable program code configured to allocate the base cost and the incremental cost of the communication flow between the network access terminal and the site to the first account associated with the user of the network access terminal.

35. The computer program product of claim 32, wherein the cost of the communication flow comprises a base cost for providing the communication flow at a base performance level and an incremental cost, in addition to the base cost, for providing the communication flow at an enhanced performance level, and wherein the computer readable program code configured to allocate the cost of the communication flow comprises:
computer readable program code configured to allocate the base cost and the incremental cost of the communication flow between the network access terminal and the site to the second account associated with an entity other than the user of the network access terminal.

36. The computer program product of claim 31, further comprising:
computer readable program code configured to use an authentication mechanism to verify that the network access terminal and/or the site is authorized to modify the performance level of the broadband communication network and/or allocation of the cost of the communication flow.

37. The computer program product of claim 36, wherein the request is a first request, the computer program product further comprising:
computer readable program code configured to receive a second request from the network access terminal and/or the site to provide the communication flow at the base performance level; and wherein computer readable program code configured to allocate the cost of the communication flow comprises:
computer readable program code configured to allocate the cost of the communication flow between the network access terminal and the site between the first account associated with the user of the network access terminal and the second account associated with at the entity other than the user of the network access terminal based on the performance level of the communication flow if the network access terminal and/or the site is authorized to modify the performance level of the broadband communication network and/or allocation of the cost of the communication flow.

38. The computer program product of claim 30, wherein the performance level is based on at least one of bandwidth of the communication flow, duration of the communication flow, latency associated with the communication flow, jitter associated with the communication flow, dropped packets associated with the communication flow, quality of service (QoS) associated with the communication flow, rate limit associated with the communication flow, traffic shaping associated with the communication flow, and priority of the communication flow.

39. The computer program product of claim 29 wherein the entity is associated with the site.

40. The computer program product of claim 29, wherein the entity is associated with a third party that is not associated with the site.
